(19) United States
(12) Patent Application Publication
(10) Pub. No.: US 2013/0019155 A1
(43) Pub. Date: Jan. 17, 2013

(54) SYSTEMS AND METHODS FOR COLLECTING MULTIMEDIA FORM RESPONSES

(71) Applicants: James H. Wolfston, JR., West Linn, OR (US); Jeff M. Bolton, Portland, OR (US)

(72) Inventors: James H. Wolfston, JR., West Linn, OR (US); Jeff M. Bolton, Portland, OR (US)

(73) Assignee: CollegeNET, Inc., Portland, OR (US)

(21) Appl. No.: 13/494,702

(22) Filed: Jun. 12, 2012

Related U.S. Application Data
(63) Continuation of application No. 13/180,330, filed on Jul. 11, 2011.

(51) Int. Cl. G06F 17/00

(52) U.S. Cl. 715/221

(57) ABSTRACT

Systems and methods for collecting multimedia responses to prompts within a web form are provided. In one embodiment, a multimedia collection engine provides a multimedia response interface element that may be included with a web form to collect a multimedia response. The multimedia response is stored in association with other web form responses, and both the web form responses and the multimedia response may be viewed by a reviewer.

### CROSS-REFERENCE TO RELATED APPLICATION

This application is a continuation of application Ser. No. 13/180,330, filed Jul. 11, 2011, the entire disclosure of which is hereby incorporated by reference herein.

### BACKGROUND

The use of web forms to capture textual information from end users is well established. However, existing solutions do not provide the ability to easily integrate multimedia form responses with said textual information. What is needed is a system and method that provides such a capability.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method for receiving a multimedia response to a prompt within a web form is provided. A web form is presented to a user by a computing device. The web form includes a prompt and a multimedia response interface element. A multimedia response to the prompt is received by the computing device from the user via the multimedia response interface element.

In some embodiments, a computing device comprising at least one processor and a computer-readable storage medium is provided. The computer-readable storage medium has computer-executable instructions stored thereon that, if executed by the processor, cause the computing device to perform actions for receiving a multimedia response to a prompt within a web form. The actions comprise presenting a web form to a user, the web form including a prompt and a multimedia response interface element; and receiving a multimedia response to the prompt from the user via the multimedia response interface element.

In some embodiments, a computer-readable medium having computer-executable components stored thereon is provided. If the computer-executable components are executed by one or more processors of a computing device, the computer-executable components cause the computing device to perform actions for receiving a multimedia response to a prompt within a web form. The actions comprise presenting a web form to a user, the web form including a prompt and a multimedia response interface element; and receiving a multimedia response to the prompt from the user via the multimedia response interface element.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an exemplary embodiment of a form processing system 100 according to various aspects of the present disclosure;

FIG. 2 is a block diagram illustrating further details of components of an exemplary embodiment of the form processing system 100 according to various aspects of the present disclosure;

FIGS. 3A-3C illustrate one embodiment of a method 300 of collecting form responses according to various aspects of the present disclosure;

FIG. 4 illustrates one embodiment of a web form submission interface 400 that may be generated according to various aspects of the present disclosure; and

FIG. 5 illustrates portions of an exemplary hardware architecture of a computing device 500 suitable for use with various embodiments of the present disclosure.

### DETAILED DESCRIPTION

Embodiments of the present disclosure provide the ability to integrate multimedia form responses along with textual responses to form prompts. In some embodiments, a computing device presents a web form to a user that includes at least a prompt and a multimedia response interface element. A computing device receives a multimedia response to the prompt from the user via the multimedia response interface element. In some embodiments, a form processing server may generate the web form and receive textual form responses, while a multimedia processing server receives the multimedia response. In some embodiments, the textual form responses and the multimedia response may be associated with each other, so that a reviewer may later review all of the responses to the web form as a cohesive form submission.

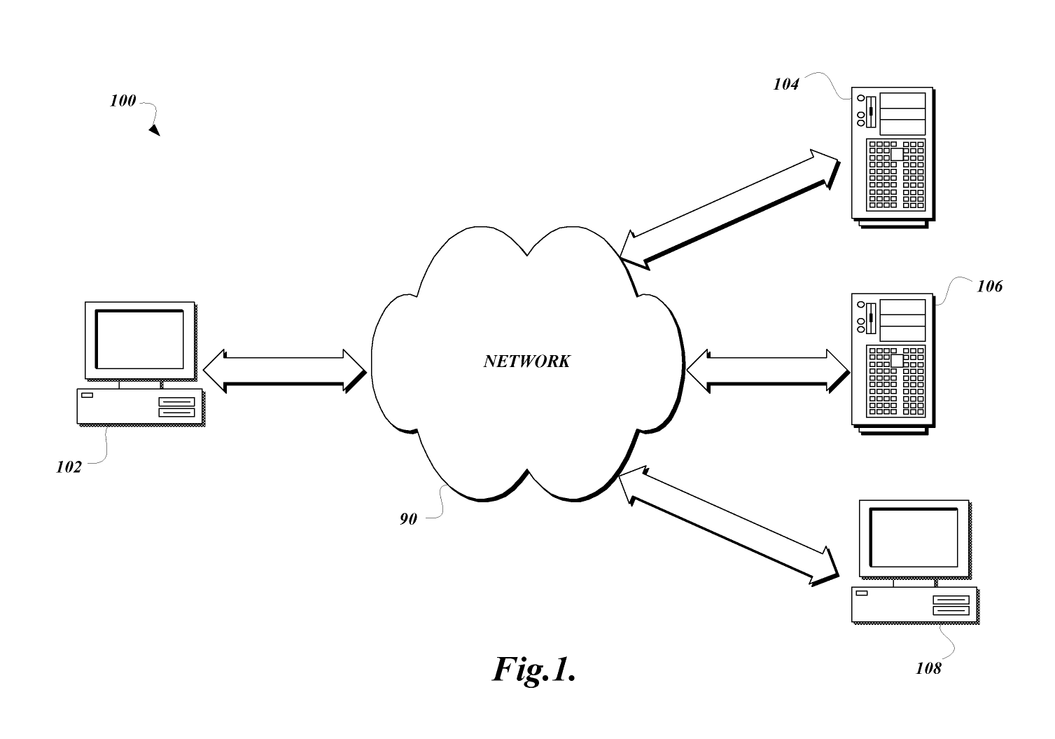

FIG. 1 illustrates one embodiment of a form processing system 100 according to various aspects of the present disclosure. The form processing system 100 includes a client device 102, a form processing server 104, a multimedia processing server 106, and a submission review device 108. The client device 102 may be a computing device operated by an end user to retrieve and submit a form generated by the form processing server 104. The client device 102 may also transmit multimedia data to the multimedia processing server 106 to be associated with the form submission. The client device 102 may be any suitable computing device, including, but not limited to, a laptop computer, a desktop computer, a mobile phone, a smart phone, a tablet computer, and/or the like. The servers 104, 106 may include suitable computing devices configured to provide services described further below.

The form processing server 104 and the multimedia processing server 106 may collaborate to associate stored multimedia data with a form submission, though in some embodiments, the form submission may be associated with the multimedia data without any direct communication between the form processing server 104 and the multimedia processing server 106. A reviewing user operating the submission review device 108 may connect to the form processing server 104 and/or the multimedia processing server 106 to browse and review form submissions and associated multimedia data submitted by end users.

The components of the form processing system 100 may communicate with each other via a network 90 such as a LAN, a WAN, a WiFi network, a Bluetooth® network, the Internet, and/or the like. Each of the devices and servers, as well as the communication between them, will be described in further detail below.

Embodiments of the form processing system 100 may be useful for entities that solicit detailed form submissions from large numbers of end users that are then reviewed by the entity. For example, in one embodiment, the form processing system 100 may be used by a college or university (or any other institution or organization) as part of its admissions process. Applications for admission may be submitted by applicants using a client device 102 connecting to the form processing server 104. The form processing server 104 may cause an application for a selected college to be displayed on the client device 102. The application may include standard textual prompts and answer fields, and may also include multimedia prompts and/or answer fields. The form processing server 104 and the multimedia processing server 106 may store the textual answers and the multimedia answers. An admissions officer of the college may use the submission review device 108 to browse and review the submissions when making admissions decisions. The college admissions embodiment should be seen as exemplary only, and not limiting, as other embodiments of the present disclosure may be used for other purposes and by other entities.

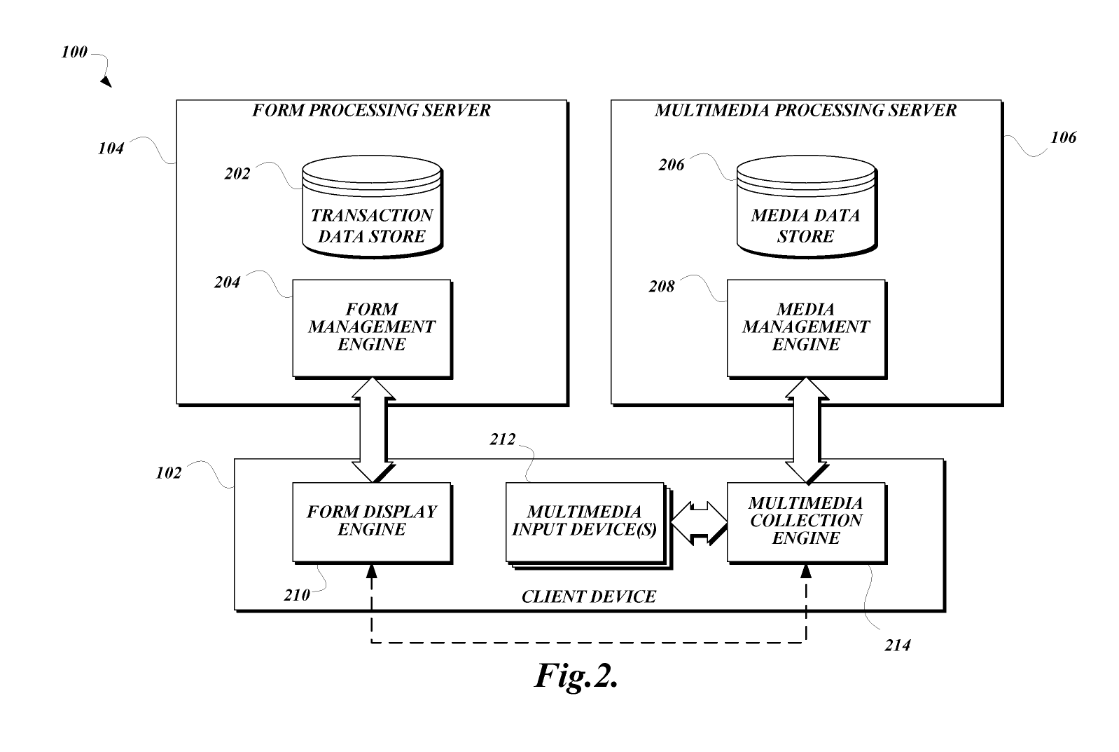

FIG. 2 is a block diagram that illustrates further details of components of one embodiment of the form processing system 100 according to various aspects of the present disclosure. The form processing server 104 includes a transaction data store 202 and a form management engine 204.

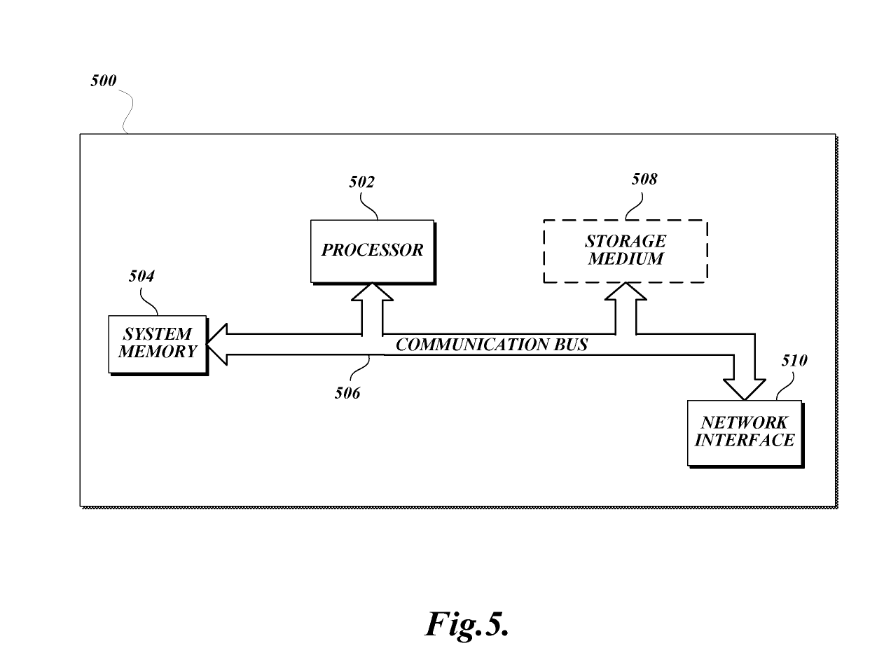

In one or more embodiments, an “engine” may include one or more computing device(s) specifically programmed to perform actions described herein as being associated with the engine. In one or more embodiments, a computing device is specifically programmed to perform the actions by having installed therein a tangible computer-readable medium having computer-executable instructions stored thereon that, when executed by one or more processors of the computing device, cause the computing device to perform the actions. An exemplary computing device is described further below with respect to FIG. 5. The particular engines described herein are included for ease of discussion. In one embodiment, actions described herein as associated with two or more engines may be performed by a single engine. In another embodiment, actions described herein as associated with a single engine may be performed by two or more separate engines.

In at least one embodiment, a “data store” includes a database that contains data as described herein as being associated with the particular data store. A data store may be hosted, for example, by a high-capacity database management system (DBMS) to allow a high level of data throughput between the data store and other components of the system 100. The DBMS may also allow the data store to be reliably backed up and to maintain a high level of availability. In one embodiment, a data store may be accessed by other components of the system 100 via a network, such as a private network in the vicinity of the system 100, a secured transmission channel over the public Internet, a combination of private and public networks, and the like. In another embodiment, instead of or in addition to a DBMS, a data store may include structured data stored as files in a traditional file system.

Though data stores are illustrated and described herein, in various embodiments, one or more of the data stores may reside on a separate computing device or devices from one or more illustrated components of the system 100. Further, although the data stores may be illustrated and described as separate entities for ease of discussion, in some embodiments, separate data stores as illustrated may be combined into a single data store, or a single data store of the illustration may be split into two or more separate data stores.

In at least one embodiment, the transaction data store 202 may store a form definition that defines elements of a form to be displayed to an end user on a client device 102. The form definition may include, for example, information defining a set of prompts to be displayed to the end user, such as questions, statements intended to elicit a response, and/or the like. The form definition may also include information defining a set of interface elements associated with the set of prompts. The interface elements, such as text boxes, radio buttons, checkboxes, drop-down boxes, multimedia response interface elements, and/or the like, may receive input from the end user in response to the prompts. In at least one embodiment, the form definition may also include information defining the layout, appearance, and behavior of elements of the form. The transaction data store 202 may also store data submitted by an end user as part of a form submission, as will be described further below.

In one embodiment, the form management engine 204 receives a request for a form from a client device 102. The end user of the client device 102 may pick the form from a list of available forms provided by the form management engine 204, or may directly submit a request for a particular form. The form management engine 204 may retrieve a definition of the form from the transaction data store 202, and may transmit the form definition to the client device 102 for presenting the form to the end user.

In at least one embodiment, the multimedia processing server 106 includes a media data store 206 and a media management engine 208. The media management engine 208 is configured to receive multimedia data from the client device 102 and to store the multimedia data in the media data store 206. In one embodiment, the media management engine 208 is configured to receive the multimedia data from the client device 102 as a data stream while it is being captured at the client device 102. In other embodiments, the media management engine 208 may receive the multimedia data as a typical file upload. The media management engine 208 is also configured to provide the stored multimedia data to the submission review device 108 to be displayed to a reviewing user. As with multimedia uploads, the media management engine 208 may be configured to stream the multimedia data to the submission review device 108, or to provide the multimedia data to the submission review device 108 as a downloadable file.

In at least one embodiment, the client device 102 includes a form display engine 210, a multimedia collection engine 214, and one or more multimedia input devices 212. The form display engine 210 is configured to request form definition information from the form processing system 100. Upon receiving the form definition information, the form display engine 210 displays form prompts and input fields to an end user and collects the end user's responses in the input fields. The form display engine 210 then transmits the end user's responses to the form processing system 100. In one embodiment, the form display engine 210 may be a standard web browser or a portion thereof, such as the Internet Explorer® browser by Microsoft Corporation, the Firefox® browser by the Mozilla Foundation, and/or the like. In another embodiment, the form display engine 210 may be a custom desktop application or mobile application specially configured to communicate with the form processing system 100.

In various embodiments, the one or more multimedia input devices 212 may be connected to the client device 102 and configured to capture multimedia data. One example of a multimedia input device 212 may be a video camera that is either separate from and communicatively coupled to the client device 102, or is an integral component of the client device 102. The exemplary video camera, when active, may provide a stream of video data for use by other components of the client device 102. Another example of a multimedia input device 212 may be a microphone that is either separate from and communicatively coupled to the client device 102, or is an integral component of the client device 102. As with the exemplary video camera, the exemplary microphone, when active, may provide a stream of audio data for use by other components of the client device 102. In some embodiments, multiple multimedia input devices 212 may be combined into a single device. For example, a video camera and a microphone may be accessible by other components of the client device 102 as a single device. As a further example, data collected by the video camera and the microphone may be provided to the client device 102 as a single data stream that includes both video and audio information. The above multimedia input devices 212 should be seen as exemplary and not limiting, as any suitable multimedia input device 212 either currently known or developed in the future may be used with the form processing system 100.

In some embodiments, the multimedia collection engine 214 is configured to capture the data streams generated by the multimedia input devices 212 for processing. The processing may include, but is not limited to, one or more of providing the data streams for presentation on one or more output devices associated with the client device 102, saving the data streams as files on a computer-readable storage medium of the client device 102, and providing the data streams to the multimedia processing server 106.

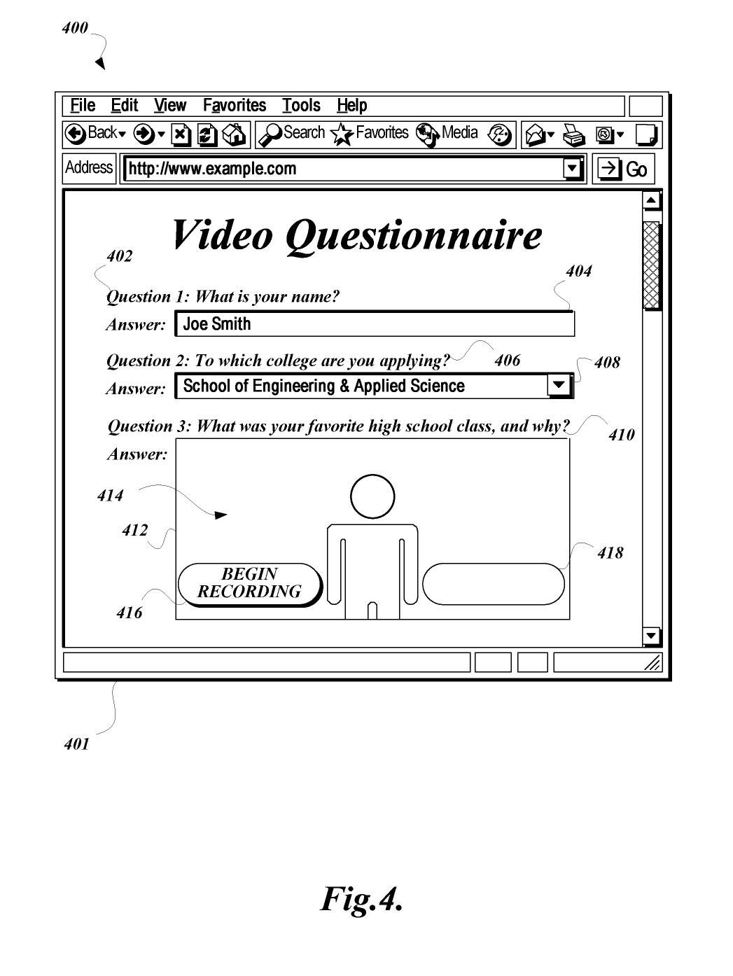

In some embodiments, an instantiation of the multimedia collection engine 214 may be initiated by the form display engine 210 upon receiving form definition information that includes a multimedia response field for collecting multimedia data from the end user. While the form display engine 210 communicates form definition information and form submission information directly with the form management engine 204, and the multimedia collection engine 214 receives multimedia data directly from the multimedia input devices 212 and provides multimedia data directly to the media management engine 208 (as represented by thick arrows in FIG. 4), in the illustrated embodiment the form display engine 210 and the multimedia collection engine 214 do not exchange such information between each other. In the illustrated embodiment, the form display engine 210 and the multimedia collection engine 214 merely exchange information usable to associate the multimedia data with the form submission information (as represented by a dashed arrow in FIG. 4).

In at least one exemplary embodiment, the multimedia collection engine 214 may include an Adobe® Flash® application that executes on the client device 102 and receives multimedia data from multimedia input devices 212 such as a webcam, a microphone, and/or the like. The media management engine 208 may include an Adobe® Flash® Media Server that receives a published multimedia stream from the multimedia collection engine 214. The multimedia collection engine 214 may receive a transaction ID from the form display engine 210 via a document object model (DOM) of the web browser, and may use the transaction ID as part of a filename used by the media management engine 208 to store the multimedia data in the media data store 206. Hence, once the submission review device 108 obtains the transaction ID for a form submission, the submission review device 108 may reconstruct the filename when requesting the multimedia data from the media management engine 208. This embodiment is exemplary only, and in other embodiments, technologies other than Adobe® Flash®, and other types of communication and/or data, may be used.

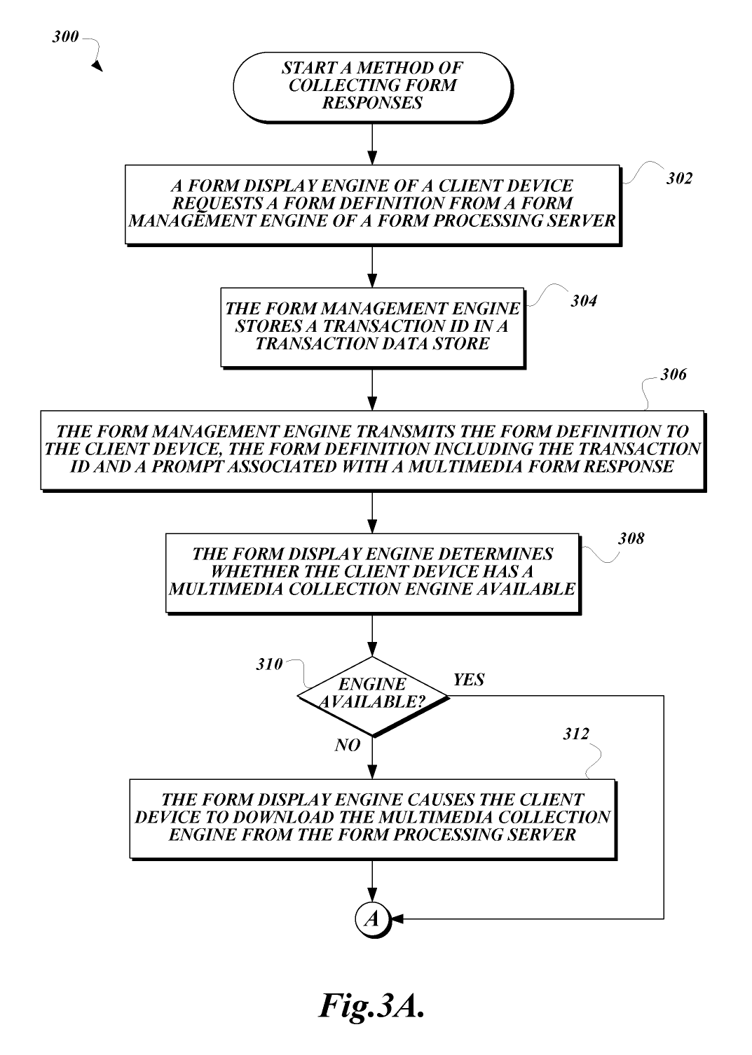

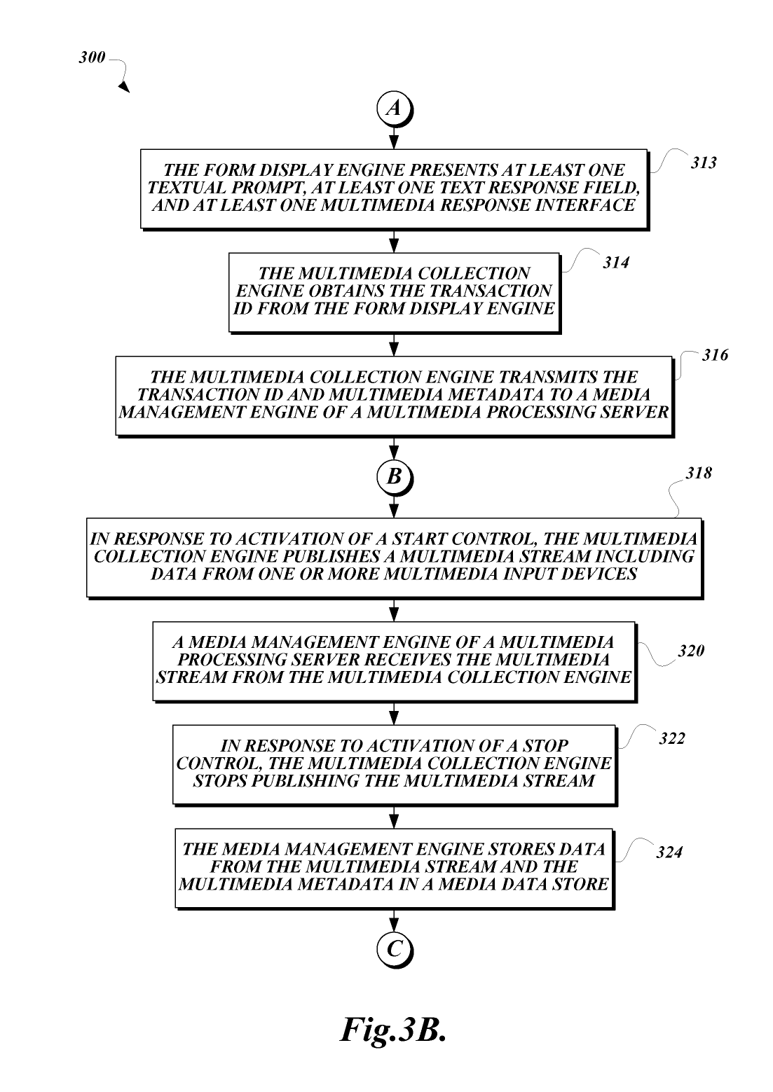

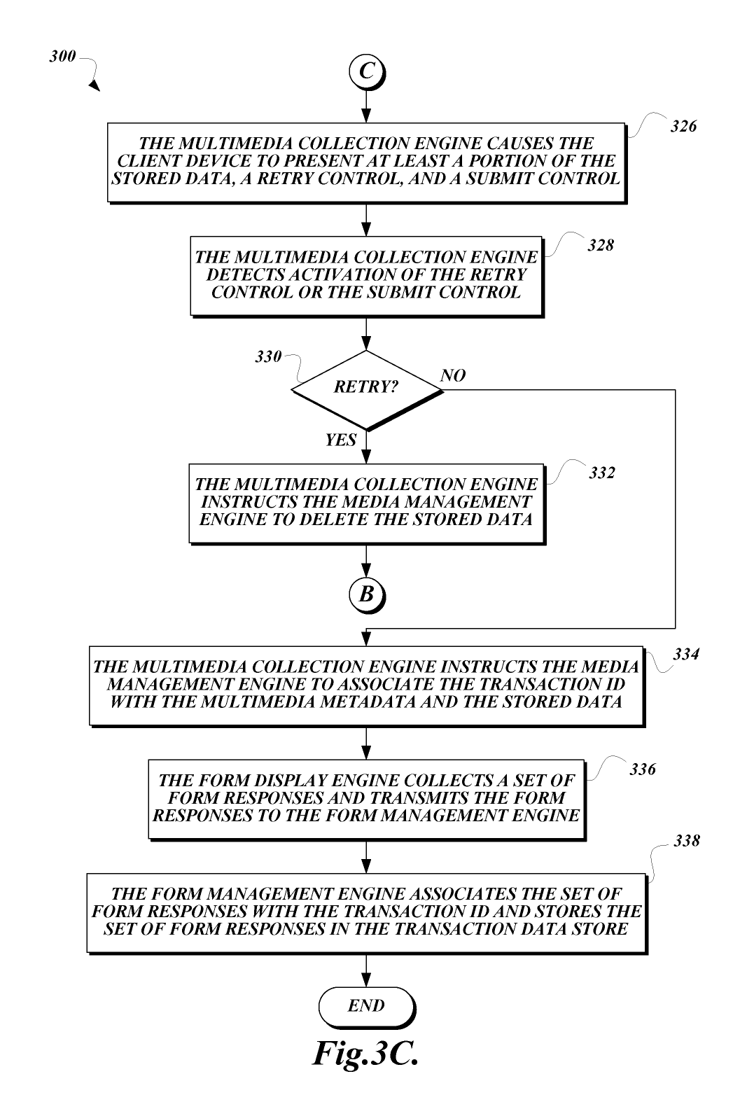

FIGS. 3A-3C illustrate one embodiment of a method 300 of collecting form responses according to various aspects of the present disclosure. From a start block, the method 300 proceeds to block 302, where a form display engine 210 of a client device 102 requests a form definition from a form management engine 204 of a form processing server 104. The form management engine may retrieve the form definition from the transaction data store 202 or from some other data store that stores the form definition. In one embodiment, the form definition may include a static set of prompts to be included. In another embodiment, the form management engine 204 may select from a set of dynamic prompts to be included with the form definition. For example, the form management engine 204 may choose randomly between prompts, such as differently worded prompts that seek similar information. As another example, the form management engine 204 may select prompts based on previous information received from an end user. As yet another example, the form management engine 204 may select prompts based on other criteria, such as information received from other users, a time or date the form is requested, demographic information about the end user or other users, and/or the like.

At block 304 of the method 300, the form management engine 204 stores a transaction ID in a transaction data store 202. The transaction ID may be used to associate multiple separate submissions received from the client device 102 into a single form submission for review. As discussed further below, the transaction ID may also be used to associate multimedia data with the other form submission data. Next, at block 306, the form management engine transmits the form definition to the client device 102, the form definition including the transaction ID and a prompt associated with a multimedia form response. As discussed above, these form definition contents are exemplary only, as the form definition may include additional information such as multiple textual prompts and text response fields. In another embodiment, the form definition may include more than one prompt associated with multimedia form responses.

At block 308, the form display engine 210 determines whether the client device 102 has a multimedia collection engine 214 available. In one embodiment, the multimedia collection engine 214 may be preinstalled on the client device 102. In another embodiment, the multimedia collection engine 214 may be included within a downloadable executable file, and may be obtained by the client device 102 when needed. In this case, the client device 102 may not have the multimedia collection engine 214 installed when a form description containing a multimedia form response is first received.

At decision block 310, a determination is made as to whether a multimedia collection engine is available on the client device 102. If the answer to the determination at decision block 310 is YES, the method 300 proceeds to a continuation terminal (“terminal A”). If the answer to the determination at decision block 310 is NO, the method 300 proceeds to block 312, where the form display engine 210 causes the client device 102 to download the multimedia collection engine 214 from the form processing server 104. In another embodiment, the client device 102 may obtain the multimedia collection engine 214 from the multimedia processing server 106 or from any other server that makes the multimedia collection engine 214 available for download. The method 300 then proceeds from block 312 to terminal A.

From terminal A (FIG. 3B), the method proceeds to block 313, where the form display engine 210 presents at least one textual prompt, at least one text response field, and at least one multimedia response interface. In at least one embodiment, the multimedia response interface may be provided by the multimedia collection engine 214. As a nonlimiting example, the multimedia collection engine may include a Flash® application configured to both capture and publish multimedia information at the client device 102, and to display the multimedia response interface within the form. As stated above, in other embodiments, the form display engine 210 may display more or fewer prompts, but a small number of interface elements are discussed herein for ease of discussion. The multimedia response interface may display its own textual prompt, or the multimedia response interface may be displayed in association with a textual prompt generated by the form display engine 210.

Next, at block 314, the multimedia collection engine 214 obtains the transaction ID from the form display engine 210. In one embodiment in which the form display engine 210 is executed in or by a standard web browser, the form display engine 210 may make the transaction ID available via the document object model (DOM) of the web browser. In this embodiment, the multimedia collection engine 214 may read the transaction ID from the DOM. In other embodiments, the multimedia collection engine 214 may obtain the transaction ID from the form display engine 210 in another way. For example, the multimedia collection engine 214 may use an inter-process communication technique such as sockets, named pipes, shared memory, and/or the like.

The method 300 then proceeds to block 316, where the multimedia collection engine 214 transmits the transaction ID and multimedia metadata to a media management engine 208 of a multimedia processing server 106. In some embodiments, the multimedia metadata may include, but are not limited to, one or more of a video ID value, a profile ID value, an xactid value, a video type value, a file path value, a video title value, a create timestamp value, an expires timestamp value, a category value, a featured yes/no value, and a video description value. In one embodiment, the video description value may be used to store prompts displayed to the end user. In one embodiment, the media management engine 208 may cause the transaction ID and multimedia data to be stored in the media data store 206. In another embodiment, the media management engine 208 may cause the transaction ID and the multimedia metadata to be stored in a temporary storage location for later storage in the media data store 206 along with associated multimedia data.

The method 300 then proceeds to a continuation terminal (“terminal B”), and then to block 318, where, in response to activation of a start control, the multimedia collection engine 214 publishes a multimedia stream including data from one or more multimedia input devices 212. The start control may be displayed by an interface of the multimedia collection engine 214 and may be activated by the end user. In one or more embodiments, the multimedia input devices 212 provide a multimedia data stream to other components of the client device 102 at any time during which the multimedia input devices 212 are active. The publishing of the multimedia stream by the multimedia collection engine 214 causes data from those streams to be made available for receipt, recording, and/or presentation by another device. The multimedia collection engine 214 may cause several streams from separate multimedia input devices 212 to be published, or may combine several streams from separate multimedia input devices 212, such as a microphone and a video camera and/or the like, into a combined published multimedia stream.

Next, at block 320, a media management engine 208 of a multimedia processing server 106 receives the multimedia stream from the multimedia collection engine 214. In one embodiment, the multimedia collection engine 214 opens a connection to the media management engine 208 once publishing begins, and uses the connection to transmit the multimedia data. In another embodiment, the multimedia collection engine 214 has a reference to a shared object executing on the multimedia collection engine 214 and the media management engine 208. In this embodiment, the multimedia collection engine 214 may call a publish method on the shared object to begin publishing the multimedia stream, which causes the multimedia stream to be transmitted to the media management engine 208.

At block 322, in response to activation of a stop control, the multimedia collection engine 214 stops publishing the multimedia stream. In at least one embodiment, the end of publication may include notifying the media management engine 208 to finalize the multimedia data or otherwise prepare the received multimedia data for long-term storage. Next, at block 324, the media management engine 208 stores data from the multimedia stream and the multimedia metadata in a media data store 206. In one embodiment, the media management engine 208 stores the data in a temporary storage portion of the media data store 206 until further indication is received from the client device 102 to store the data permanently. The method 300 then proceeds to a continuation terminal (“terminal C”).

From terminal C (FIG. 3C), the method 300 proceeds to block 326, where the multimedia collection engine 214 causes the client device 102 to present at least a portion of the stored multimedia data, a retry control, and a submit control. This allows the end user to review the recorded multimedia data before indicating that it should be included with the form submission, and to re-record the submission if the original is unsuitable. Next, at block 328, the multimedia collection engine 214 detects activation of either the retry control or the submit control. Activation of the submit control indicates that the end user believes the previously recorded multimedia data is suitable for inclusion with the form submission, and activation of the retry control indicates that the end user believes the previously recorded multimedia data is unsuitable. At decision block 330, a determination is made as to whether the retry control was activated or the submit control was activated. If the retry control was activated and the answer to the test at decision block 330 is YES, the method 300 proceeds to block 332, where the multimedia collection engine 214 instructs the media management engine 208 to delete the stored multimedia data (or to simply not flag the stored multimedia data for permanent storage), and then proceeds to continuation terminal B to obtain replacement multimedia data.

Otherwise, if the submit control was activated and the answer to the test at decision block 330 is NO, the method 300 proceeds to block 334, where the multimedia collection engine 214 instructs the media management engine 208 to associate the transaction ID with the multimedia metadata and the stored multimedia data. In one embodiment discussed above, the media management engine 208 may associate the transaction ID with the multimedia metadata and the stored multimedia data by creating a filename for the stored multimedia data in the media data store 206 based on the transaction ID and/or the multimedia metadata. In another embodiment, the media management engine 208 may add an entry or set a flag in a record of the media data store 206 associated with the transaction ID indicating that the stored multimedia data has been approved for inclusion with the form submission associated with the transaction ID.

In one embodiment, the actions described in blocks 326-332 that provide the end user the ability to review, retry, or re-record the multimedia data may be optional. Accordingly, the actions described in these blocks may be omitted without departing from the scope of the invention.

At block 336, the form display engine 210 collects a set of form responses and transmits the form responses to the form management engine 204. In one embodiment, the set of form responses may include text data entered by an end user into text input fields in response to prompts associated with the text input fields. The set of form responses may also include other types of form data, such as values generated from selections of radio buttons, checkboxes, drop-down boxes, and/or any other type of form input control.

At block 338, the form management engine 204 associates the set of form responses with the transaction ID and stores the set of form responses in the transaction data store 202. In this way, the form responses stored by the form processing server 104 may be associated with the multimedia data stored by the multimedia processing server 106. In an embodiment in which the prompts in the form definition are dynamically selected, the transaction data store 202 may also store an identification of the prompts that were included in the form definition along with the set of form responses. One of ordinary skill in the art can appreciate that, in some embodiments, the blocks of the method 300 described herein may be performed in different orders, and in particular, the actions described in blocks 336 and 338 may be performed before, during, or after the collection of multimedia data.

After block 338, when the data for a form submission has been collected and stored by the form processing server 104 and the multimedia processing server 106, the method 300 proceeds to an end block and terminates.

Once form submissions are received and stored by the form processing server 104 and the multimedia processing server 106, a submission reviewer may connect to the form processing system 100 using a submission review device 108 to browse and review the form submissions. In at least one embodiment, the submission reviewer may connect to the form processing server 104 which provides the submission review device 108 with information identifying a list of form submissions. The submission reviewer selects a form submission from the list of form submissions. The form processing server 104 retrieves the form submission information from the transaction data store 202, and transmits it to the submission review device 108 for display. In one embodiment, the form submission information includes the transaction ID, a record of the information submitted by the end user, and a record of the prompts displayed to the end user. As the multimedia data is stored by the multimedia processing server 106 and not the form processing server 104, the submission review device 108 may use the transaction ID to retrieve the multimedia data corresponding to the selected form submission from the multimedia processing server 106.

FIG. 4 illustrates one embodiment of a web form submission interface 400 that may be generated according to various aspects of the present disclosure. The illustrated web form submission interface 400 is depicted as being hosted by a traditional web browser 401. The interface elements displayed by the web browser 401 are output of the form display engine 210, which may include code downloaded by the web browser 401 for providing a web form, such as AJAX code, HTML5 markup, earlier versions of HTML markup, and/or the like. Some components of the form display engine 210, such as standard form interface elements and/or the like, may be provided by the web browser 401 and may be directed to be displayed by code, markup language, and/or the like downloaded from the from processing server 104.

As illustrated, the web form submission interface 400 includes a first prompt 402 paired with a text response field 404, a second prompt 406 paired with a dropdown response field 408, and a third prompt 410 paired with a multimedia response interface element 412. Each of the prompts and interface elements may be specified in the form definition received by the form display engine 210, along with information concerning their layout and behavior within the web form submission interface 400. As one of skill in the art will recognize, the text response field 404 provides the input text as the value of the field upon submission of the form, and the dropdown response field 408 provides a value associated with the chosen element as the value of the field upon submission of the form.

As may be typical, the first prompt 402 and the second prompt 406 are easily answered by providing a short text string or by picking an element from a finite list of possibilities. The third prompt 410 presents an open ended question that may not be easily answered in a written format, for which a multimedia response may be particularly suitable.

The multimedia response interface element 412 is one embodiment of the multimedia collection engine 214 described above. The multimedia response interface element 412 includes a video feed display 414 on which a video image of the end user captured from a multimedia input device 212 is provided. The multimedia response interface element 412 also includes a start control 416 and a stop control 418. As illustrated, the multimedia response interface element 412 may be awaiting activation of the start control 416, at which point the multimedia collection engine 214 will begin publishing the multimedia data reflected in the video feed display 414 until activation of the stop control 418.

In one embodiment, the start control 416 and the stop control 418 may be actuated by a keystroke, by voice activation, and/or the like, instead of by a mouse click, thus allowing the controls to be activated without requiring the end user to interact with the mouse, thereby enabling the end user to record a more natural looking video. In other embodiments, the multimedia response interface element 412 may include other features that help produce high quality multimedia responses, such as countdown timers before recording starts, post-recording video editing functionality, and/or the like. In another embodiment, the multimedia response interface element 412 may impose a time limit on the length of the recorded video response.

As stated above, the illustrated web form submission interface 400 should be seen as exemplary only, and not limiting. In other embodiments, the form display engine 210 or portions thereof may be provided in a standalone application, a custom app executed by a mobile device, a server application executing in the cloud, and/or the like.

In one embodiment, the form processing system 100 may be used by a single institution for a single type of form. However, in another embodiment, the form processing system 100 may be used by an institution for multiple types of forms, or may be used by multiple institutions. For example, in one embodiment, the form processing system 100 may provide college application form processing services for multiple different colleges. The form processing system 100 may provide customized interfaces particular to each college, even though data for multiple colleges may reside in a single transaction data store 202 or media data store 206.

While particular embodiments in the above discussion relate to processing college applications, in other embodiments, the form processing system 100 may be useful in other situations. As a nonlimiting example, the form processing system 100 may be used to process other types of forms, such as job applications, scholarship applications, grant applications, polls, and other submissions of information for review. As another nonlimiting example, the form processing system 100 may be used to process information used to build an online profile, such as for a social networking web site, a dating web site, an online directory, and/or the like. The form processing system 100 may also be suitable for collecting multimedia information for reasons other than those stated above.

FIG. 5 illustrates portions of an exemplary hardware architecture of a computing device 500 suitable for use with various embodiments of the present disclosure. While FIG. 5 is described with reference to a computing device that acts as a client on a network, the description below is also applicable to servers and other devices that may be used to implement embodiments of the present disclosure. Moreover, those of ordinary skill in the art and others will recognize that the computing device 500 may be any one of any number of currently available or yet to be developed devices.

In its most basic configuration, the computing device 500 includes at least one processor 502 and a system memory 504 connected by a communication bus 506. Depending on the exact configuration and type of device, the system memory 504 may be volatile or nonvolatile memory, such as read only memory (“ROM”), random access memory (“RAM”), EEPROM, flash memory, or similar memory technology. Those of ordinary skill in the art and others will recognize that system memory 504 typically stores data and/or program modules that are immediately accessible to and/or currently being operated on by the processor 502. In this regard, the processor 502 serves as a computational center of the computing device 500 by supporting the execution of instructions.

As further illustrated in FIG. 5, the computing device 500 may include a network interface 510 comprising one or more components for communicating with other devices over the network. The computing device 500 may utilize the network interface 510 to perform communications using common network protocols. In the exemplary embodiment depicted in FIG. 5, the computing device 500 also includes a storage medium 508. The storage medium 508 depicted in FIG. 5 is represented with a dashed line to indicate that the storage medium 508 may be optional, as the computing device 500 may include a removable computer-readable storage medium 508, or may not include a computer-readable storage medium 508 beyond that used to store instructions for execution by the processor 502 and may instead access storage media via the network interface 510. In any event, when present, the storage medium 508 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and the like.

As used herein, the term “computer-readable medium” includes volatile and non-volatile, as well as removable and non-removable media implemented in any method or technology capable of storing information, such as computer-executable instructions, data structures, program modules, and/or other data. In this regard, the system memory 504 and storage medium 508 depicted in FIG. 5 are merely examples of computer-readable media.

Suitable implementations of computing devices that include a processor 502, system memory 504, communication bus 506, storage medium 508, and network interface 510 are known and commercially available. For ease of illustration and because it is not important for an understanding of the claimed subject matter, FIG. 5 does not show some of the typical components of many computing devices. In this regard, the computing device 500 may typically include input devices, such as a keyboard, mouse, microphone, touch input device, and/or the like. Similarly, the computing device 500 may also include output devices such as a display, speakers, printer, and/or the like. Since all these devices are commonly available and well known in the art, they are not described further herein.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method for receiving a multimedia response to a prompt within a web form, the method comprising:
presenting, by a computing device, a web form to a user, the web form including a prompt and a multimedia response interface element; and
receiving, by a computing device, a multimedia response to the prompt from the user via the multimedia response interface element.

2. The computer-implemented method of claim 1, wherein the prompt is presented to the user as text.

3. The computer-implemented method of claim 1, wherein the prompt is presented to the user as multimedia that includes video.

4. The computer-implemented method of claim 1, wherein the prompt is presented to the user as multimedia that includes audio.

5. The computer-implemented method of claim 1, wherein the web form includes at least one additional prompt, and wherein the method further comprises collecting a text response from the user to the at least one additional prompt.

6. The computer-implemented method of claim 1, wherein receiving a multimedia response to the prompt from the user via the multimedia response interface element includes:
receiving a first multimedia response from the user; and
receiving a second multimedia response from the user in response to a request from the user to re-record the first multimedia response.

7. The computer-implemented method of claim 1, wherein receiving a multimedia response to the prompt from the user via the multimedia response interface element includes enforcing a time limit for the multimedia response to the question.

8. The computer-implemented method of claim 1, wherein receiving a multimedia response to the prompt includes receiving a multimedia data stream published by the multimedia response interface element.

9. The computer-implemented method of claim 1, further comprising transmitting the multimedia response to a server.

10. The computer-implemented method of claim 1, wherein the multimedia response includes at least one of audio and video.

11. A computing device, comprising:
at least one processor; and
a computer-readable storage medium having computer-executable instructions stored thereon that, if executed by the processor, cause the computing device to perform actions for receiving a multimedia response to a prompt within a web form, the actions comprising:
presenting a web form to a user, the web form including a prompt and a multimedia response interface element; and
receiving a multimedia response to the prompt from the user via the multimedia response interface element.

12. The computing device of claim 11, wherein the web form includes at least one additional prompt, and wherein the actions further comprise collecting a text response from the user to the at least one additional prompt.

13. The computing device of claim 11, wherein receiving a multimedia response to the prompt from the user via the multimedia response interface element includes:
receiving a first multimedia response from the user; and
receiving a second multimedia response from the user in response to a request from the user to re-record the first multimedia response.

14. The computing device of claim 11, wherein receiving a multimedia response to the prompt from the user via the multimedia response interface element includes enforcing a time limit for the multimedia response to the question.

15. The computing device of claim 11, wherein receiving a multimedia response to the prompt includes receiving a multimedia data stream published by the multimedia response interface element.

16. The computing device of claim 11, wherein the actions further comprise transmitting the multimedia response to a server.

17. A computer-readable medium having computer-executable components stored thereon that, if executed by one or more processors of a computing device, cause the computing device to perform actions for receiving a multimedia response to a prompt within a web form, the actions comprising:
presenting a web form to a user, the web form including a prompt and a multimedia response interface element; and
receiving a multimedia response to the prompt from the user via the multimedia response interface element.

18. The computer-readable medium of claim 17, wherein the web form includes at least one additional prompt, and wherein the actions further comprise collecting a text response from the user to the at least one additional prompt.

19. The computer-readable medium of claim 17, wherein receiving a multimedia response to the prompt from the user via the multimedia response interface elements includes:
receiving a first multimedia response from the user; and
receiving a second multimedia response from the user in response to a request from the user to re-record the first multimedia response.

20. The computer-readable medium of claim 17, wherein the actions further comprise transmitting the multimedia response to a server.
